(19) United States
(12) Patent Application Publication
(10) Pub. No.: US 2026/0001071 A1
(43) Pub. Date: Jan. 1, 2026

(54) INTERGRATED MICRO-DROPLET CHIP AND MICRODROPLET MULTI-INDEX DETECTION METHOD THEREFOR

(71) Applicant: TARGETINGONE TECHNOLOGY (BEIJING) CORPORATION, Beijing (CN)

(72) Inventors: Shisheng SU, Beijing (CN); Jinwei LIU, Beijing (CN); Lei XIA, Beijing (CN); Bo WANG, Beijing (CN); Wenjun YANG, Beijing (CN)

(73) Assignee: TARGETINGONE TECHNOLOGY (BEIJING) CORPORATION, Beijing (CN)

(21) Appl. No.: 18/880,660

(22) PCT Filed: Mar. 18, 2023
(86) PCT No.: PCT/CN2023/082373

§ 371 Date: Jan. 2, 2025

(30) Foreign Application Priority Data
Jul. 5, 2022 (CN) 202210781877.3
Jul. 5, 2022 (CN) 202210781929.7
Jul. 5, 2022 (CN) 202221708244.1
Jul. 5, 2022 (CN) 202221708607.1

(51) Int. Cl. B01L 3/00

(52) U.S. Cl. CPC B01L 3/502715

(57) ABSTRACT

The present application provides an integrated droplet chip and a droplet multi-index detection method therefor and belongs to the technical field of digital PCR analyzers. The chip comprises a chip body, the chip body being constructed with at least one set of one-to-many mixing and reaction structures, a droplet generating structure and a fluorescence detection area, and each of the one-to-many mixing and reaction structures comprises: a primary reaction chamber, used for performing primary amplification, so that a detection sample with a first concentration in the primary system is amplified to form a detection sample with a second concentration, wherein the second concentration is higher than the first concentration; a plurality of sampling chambers; and the plurality of sampling chambers are controllably connected to the same primary reaction chamber at the same time; a plurality of secondary reaction chambers, which are controllably connected to the plurality of sampling chambers in a one-to-one correspondence, are used to store the droplets generated by the detection sample of the second concentration and the secondary system at the droplet generating structure and perform secondary amplification. The present application effectively increases the concentration of the detection sample. The detection sample having the increased concentration is divided into more detection samples to ensure that each detection sample has a relatively high concentration, thereby achieving multi-index detection of a low-concentration sample, ensuring the sensitivity of sample detection, and improving the accuracy of detection results.

The present invention claims the priority of the Chinese patent application filed on Jul. 5, 2022 with application number 202210781877.3, entitled “Integrated multi-index detection droplet chip”, the priority of the Chinese patent application filed on Jul. 5, 2022 with application number 202221708244.1, entitled “Integrated pre-amplification droplet chip”, the priority of the Chinese patent application filed on Jul. 5, 2022 with application number 202210781929.7, entitled “Droplet multi-index detection method for integrated droplet chip”, and the priority of the Chinese patent application filed on Jul. 5, 2022 with application number 202221708607.1, entitled “Integrated multi-index detection droplet chip”, all of which are incorporated by reference into the present invention.

### TECHNICAL FIELD

The present invention belongs to the technical field of digital PCR analyzers, and in particular relates to integrated droplet chip and droplet multi-index detection method therefor.

### BACKGROUND TECHNOLOGY

Digital PCR technology is known as the third generation PCR technology, which has the advantages of absolute quantification and single molecule detection sensitivity, and has important application prospects in the field of molecular diagnosis. One of the mainstream technical routes in digital PCR technology is to use a droplet microfluidic chip, in which the reaction system is divided into tens of thousands or even millions of droplets of uniform size (i.e., droplets), and each droplet independently carries out the nucleic acid amplification and fluorescence detection, and the precise copy number of the target molecule in the sample is calculated using a mathematical model based on the fluorescence detection results.

Although digital PCR technology has the advantages of high detection sensitivity and absolute quantification, it still faces considerable challenges in low-concentration (also known as low-abundance) nucleic acid detection scenarios. For example, in the fields of tumor liquid biopsy, organ transplant rejection monitoring, and pathogen ultrasensitive detection, it is not only required to detect rare target sequences in a large number of background samples, but also to differentiate between multiple possible rare target sequences at the same time. Digital PCR is limited by the spectral distribution of fluorescent dyes, and only several fluorescent probes can be placed in a sample, corresponding to several detection targets, making it difficult to meet the requirement of distinguishing dozens of target sequences at the same time. In order to improve the multi-index detection of digital PCR, it is often necessary to divide the sample into multiple portions for detection, and each portion detects several different target sequences, so as to meet the requirements of the number of indicators. However, splitting the samples with low concentration will bring the problem of reduced sensitivity, which will directly affect the accuracy of the detection results.

### SUMMARY OF THE INVENTION

Therefore, the technical problem to be solved by the present invention is to provide an integrated droplet chip and droplet multi-index detection method therefor, in order to overcome the shortcomings of the prior art in which a low concentration of a detection sample is divided into too many portions of the detection sample during detection, resulting in reduced sensitivity of the detection and inaccurate detection results.

To solve the above problem, the present invention provides an integrated multi-index which comprises a chip body, the chip body being constructed with at least one set of one-to-many mixing and reaction structures, a droplet generating structure and a fluorescence detection area corresponding to each of the one-to-many mixing and reaction structures, and each of the one-to-many mixing and reaction structures comprises: a primary reaction chamber, used for storing a primary system and performing primary amplification, so that a detection sample with a first concentration in the primary system is amplified to form a detection sample with a second concentration, wherein the second concentration is higher than the first concentration; a plurality of sampling chambers, used for storing a secondary system, and the plurality of sampling chambers are controllably connected to the same primary reaction chamber at the same time; a plurality of secondary reaction chambers, which are controllably connected to the plurality of sampling chambers in a one-to-one correspondence, are used to store the droplets generated by the detection sample of the second concentration and the secondary system at the droplet generating structure and perform secondary amplification; the fluorescence detection area which is used for detecting droplets after secondary amplification.

In some embodiments, the primary reaction chamber has a plurality of first liquid outlet pipes connected in parallel, each of the sampling chambers has a second liquid outlet pipe respectively, the second liquid outlet pipe of each of the sampling chambers is aggregated in a mixing pipe in a one-to-one correspondence with a plurality of the first liquid outlet pipes, and a plurality of the mixing pipes are controllably connected to a plurality of the secondary reaction chambers in a one-to-one correspondence respectively.

In some embodiments, each of the one-to-many mixing and reaction structures further comprises a plurality of fluid flow driving structures, the number of the fluid flow driving structures being equal to the number of the mixing pipes, each of the fluid flow driving structures comprising a gas-liquid interface constructed on the chip body, through which a first pressure difference can be formed between the corresponding primary reaction chamber and the secondary reaction chamber and between the sampling chamber and the secondary reaction chamber, so that the fluids inside the primary reaction chamber and the sampling chamber respectively flow into the corresponding mixing pipes under the action of the first pressure difference.

In some embodiments, each of the fluid flow driving structures further comprises an oil-fluid interface constructed on the chip body, and the oil interface intersects with the mixing pipe through an oil pipe, so that the fluid can be divided into a plurality of droplets when flowing through the intersection of the oil pipe and the mixing pipe.

The present invention also provides a droplet multi-index detection method of the integrated multi-index detection droplet chip as described above, comprising the following steps:
a primary amplification reaction step, controlling the heating of the primary system stored in the primary reaction chamber, so that the detection sample in the primary system is amplified from a first concentration to a second concentration, and the second concentration is higher than the first concentration;
a sample diverting and mixing step, controlling the formation of a first pressure difference between the primary reaction chamber and the secondary reaction chamber, the sampling chamber and the secondary reaction chamber respectively, so that the detection sample with the second concentration is mixed with the secondary system in the sampling chamber to form a mixed detection sample;
a droplet generation step, dividing the mixed detection sample into a plurality of droplets under the action of oil in the droplet generation structure, and controlling the formed droplets to enter the secondary reaction chamber;
a secondary amplification reaction step, controlling the heating of the droplets stored in the secondary reaction chamber to form secondary amplification;
a droplet fluorescence detection step, performing multi-index fluorescence detection on the mixed detection sample after secondary amplification at the fluorescence detection area.

In some embodiments, the droplet generation step specifically comprises: controlling the formation of a second pressure difference between the sampling chamber and the gas-liquid interface, and controlling the formation of a third pressure difference between the oil-liquid interface and the gas-liquid interface, the second pressure difference and the third pressure difference driving the mixed detection sample and the generating oil in the mixing pipe, respectively, at the intersection of the oil-liquid pipes and the mixing pipes to form the droplets and driving the droplets formed into the secondary reaction chamber.

In some embodiments, prior to the secondary amplification reaction step and after the droplet generation step further comprises a chip flip step, controlling the chip body to flip up and down by 180°.

In some embodiments, after controlling the chip body to be flipped up and down 180°, it further comprises: a droplet reverse flow control step, controlling the injection of detection driving oil into the secondary reaction chamber, so that the droplets in the secondary reaction chamber can be driven to flow into the mixing pipe and can be stored in the sampling chamber after the droplets have completed a droplet fluorescence detection step.

The present invention also provides an integrated pre-amplification droplet chip, comprising a chip body, the chip body is constructed with at least one set of mixing and reaction structures, fluorescence detection areas set up in correspondence with each of the mixing and reaction structures, each of the mixing and reaction structures comprising:
a primary reaction chamber, used to store a primary system and perform primary amplification, so that a detection sample with a first concentration in the primary system is amplified to form a detection sample with a second concentration, and the second concentration is higher than the first concentration;
a sampling chamber, used to store a secondary system, and the sampling chamber is controllably connected to the primary reaction chamber at the same time;
a secondary reaction chamber, which is controllably connected to the sampling chamber and the primary reaction chamber through a mixing pipe, and the detection sample with the second concentration and the secondary system are mixed in the mixing pipe and stored in the secondary reaction chamber in the form of droplets and undergo secondary amplification;
the fluorescence detection area is used to detect droplets (5) after the secondary amplification is completed.

In some embodiments, the chip body also has a heating groove disposed adjacent to the primary reaction chamber, and the primary amplification heating module has a heating protrusion, which can be inserted into the heating groove.

In some embodiments, the mixing pipe has a plurality of successive bends.

In some embodiments, with the first side surface of the chip body being in a horizontal position as a reference, the secondary reaction chamber, the sampling chamber, and the primary reaction chamber are all located on the first side surface, and the connection interface between the secondary reaction chamber and the first side surface of the chip body extends upward and forms a trumpet-shaped mouth that is small at the bottom and large at the top.

In some embodiments, a gas-liquid pipe extending from bottom to top is also constructed in the secondary reaction chamber, the lower end of the gas-liquid pipe is connected to the gas-liquid interface, and the upper end of the gas-liquid pipe is higher than the upper end of the connection interface.

The present invention provides an integrated droplet chip and droplet multi-index detection method therefor, wherein the chip body has at least one one-to-many mixing and reaction structure, and each one-to-many mixing and reaction structure has a primary reaction chamber, a plurality of sampling chambers and a plurality of secondary reaction chambers, so that the detection sample is first pre-amplified before generating droplets, effectively improving the concentration of the detection sample. The detection sample with increased concentration can be divided into more detection sample portions under the action of the one-to-many mixing and reaction structure to ensure that each detection sample has a higher concentration, thereby realizing multi-index detection of low-concentration samples, ensuring the sensitivity of sample detection, and improving the accuracy of the detection result. At the same time, the primary reaction chamber, the sampling chamber and the secondary reaction chamber in the technical solution are all integrated and constructed on the same chip body, so that the primary amplification, the mixing of samples with different systems, the generation of droplets, the secondary amplification and the droplet detection are integrated on the same chip, and the integration and automation levels can be improved, which is an important technical breakthrough in the field of digital PCR.

### BRIEF DESCRIPTION OF THE DRAWINGS

FIG. 1 is a schematic diagram of the principle of one-to-many reaction detection modules (specifically exemplified as one-to-four) in the integrated multi-index detection droplet chip of an embodiment of the present invention;

FIG. 2 is a schematic diagram of a three-dimensional structure of the integrated multi-index detection droplet chip of an embodiment of the present invention, in which two one-to-four reaction detection modules are shown on the same chip body;

FIG. 3 shows a schematic diagram of a specific realization of a mixing pipe in the integrated multi-index detection droplet chip of the embodiment of the present invention;

FIG. 4 shows a schematic diagram of the internal structure of the integrated multi-index detection droplet chip of FIG. 2;

FIG. 5 shows a schematic diagram of a droplet generation process of an embodiment of the present invention;

FIG. 6 shows a schematic diagram of the storage of droplets in a secondary reaction chamber after generation;

FIG. 7 is a schematic diagram of the state inside the secondary reaction chamber after the integrated multi-index detection droplet chip in FIG. 2 is flipped up and down by 180°;

FIG. 8 is a diagram of the state of the secondary amplification heating module in conjunction with the secondary reaction chamber;

FIG. 9 shows a schematic diagram of the state in the state of FIG. 7 after the oil (i.e., detection driving oil) is passed into the secondary reaction chamber;

FIG. 10 shows a schematic diagram of the droplet fluorescence detection process;

FIG. 11 is a schematic diagram of the three-dimensional structure of the internal structure of the integrated multi-index detection droplet chip of another embodiment of the present invention, in which the secondary reaction chamber and the sampling chamber and the primary reaction chamber are on both sides of the first side of the chip body, respectively;

FIG. 12 shows a schematic diagram of the principle of a one-to-two reaction detection module in another embodiment of the present invention;

FIG. 13 shows a schematic diagram of the principle of a one-to-eight reaction detection module in another embodiment of the present invention;

FIG. 14 shows a schematic diagram of the principle of the integrated pre-amplification droplet chip in another embodiment of the present invention;

FIG. 15 shows a schematic diagram of a secondary reaction chamber in the integrated multi-index detection droplet chip of an embodiment of the present invention, wherein a fluorescence detection area is integrated in the secondary reaction chamber.

The accompanying drawing markings are represented as:
1, a chip body; 11, a primary reaction chamber; 111, a connection interface; 12, a sampling chamber; 13, a secondary reaction chamber; 14, a gas-liquid interface; 15, an oil-liquid interface; 16, a fluorescence detection area; 2, a sealing cover; 31, a first liquid outlet pipe; 32, a second liquid outlet pipe; 33, a mixing pipe; 34, a gas-liquid pipe; 35, an oil-liquid pipe; 36, a droplet observation area; 4, primary amplification heating module; 41, heating protrusion; 5, droplets; 6, detection driving oil; 7, secondary amplification heating module.

### DETAILED DESCRIPTION OF THE INVENTION

### Example 1

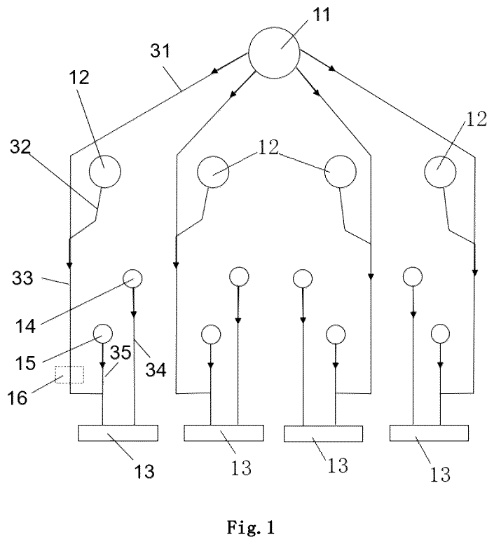

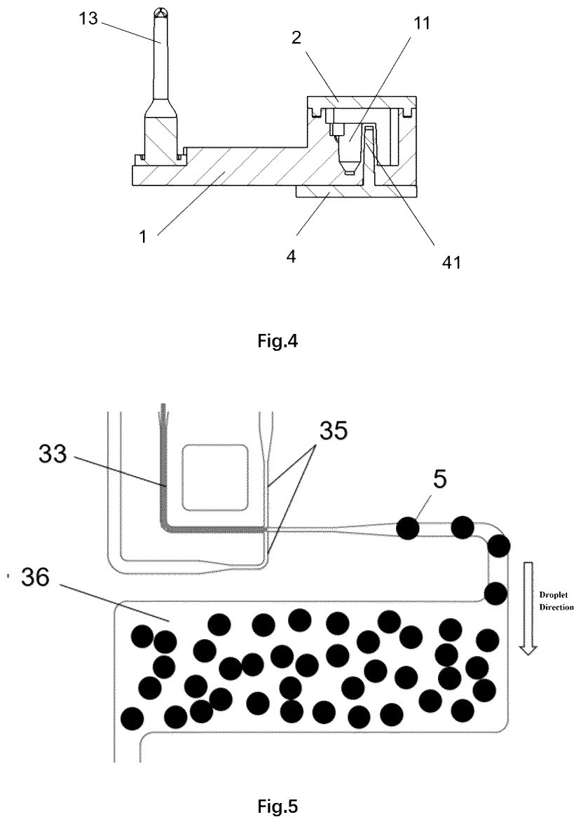

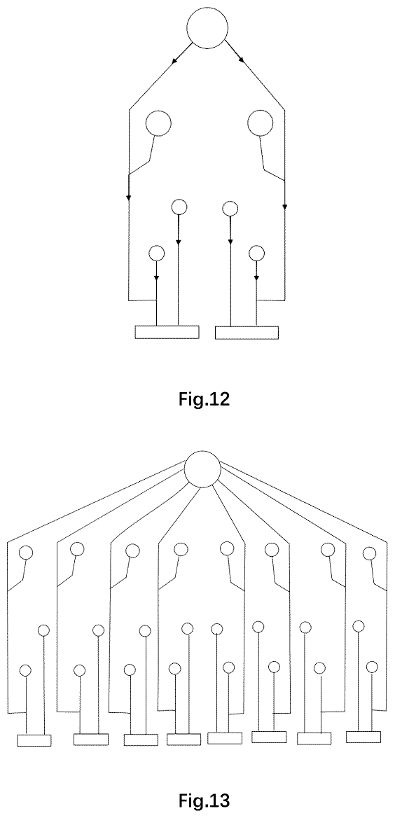

With reference to FIGS. 1 to 13, there is provided, according to an embodiment of the present invention, an integrated multi-index detection droplet chip comprising a chip body 1, the chip body 1 being constructed with at least one set of one-to-many mixing and reaction structures, a droplet generating structure and a fluorescence detection area 16 corresponding to each of the one-to-many mixing and reaction structures, and each of the one-to-many mixing and reaction structures comprises: a primary reaction chamber 11, used for storing a primary system and performing primary amplification (which may also be referred to as pre-amplification), so that a detection sample (specifically, for example, a nucleic acid sample) with a first concentration in the primary system is amplified to form a detection sample with a second concentration, wherein the second concentration is higher than the first concentration; a plurality of (at least two) sampling chambers 12, used for storing a secondary system, and the plurality of sampling chambers 12 are controllably connected to the same primary reaction chamber 11 at the same time; a plurality of secondary reaction chambers 13 (at least two and the number is equal to the number of sampling chambers 12 in the same one-to-many mixing and reaction structure), which are controllably connected to the plurality of sampling chambers 12 in a one-to-one correspondence, are used to store the droplets 5 (specifically, for example, water-in-oil droplets) generated by the detection sample of the second concentration and the secondary system at the droplet generating structure and perform secondary amplification, the fluorescence detection area 16 which is used for detecting droplets 5 after secondary amplification. Specifically, the aforementioned primary system contains the sample to be detected (specifically, for example, the nucleic acid sample) and the pre-amplification system, while the secondary system contains the digital PCR system and a stabilizer required for preparing droplets, and different secondary systems, i.e., different primers and probes, may be added to the different sampling chambers 12 according to the actual detection requirements, so as to achieve the detection of different target sequences. The one-to-many mixing and reaction structure can be realized in various forms, such as the one-to-two reaction detection module shown in FIG. 12, or the one-to-four reaction detection module shown in FIG. 1, or the one-to-eight reaction detection module shown in FIG. 13, and it can be understood that it should be at least one-to-many should be at least one-to-two.

In this technical solution, the chip body 1 has at least one one-to-many mixing and reaction structure, and each one-to-many mixing and reaction structure has a primary reaction chamber 11, a plurality of sampling chambers 12, and a plurality of secondary reaction chambers 13, so as to enable the detection sample to be pre-amplified (i.e., the aforementioned primary amplification) firstly prior to the generation of the droplet 5, so as to effectively increase the concentration of the detection sample, and to effectively improve the concentration of the detection sample. The detection sample with increased concentration can be divided into more detection sample portions under the action of the one-point-to-many mixing and reaction structure to ensure that each detection sample has a higher concentration, thereby realizing multi-index detection of low-concentration samples, ensuring the sensitivity of sample detection, and improving the accuracy of the detection results. At the same time, the primary reaction chamber 11, the sampling chamber 12 and the secondary reaction chamber 13 in the technical solution are all integrated on the same chip body 1, so that the primary amplification, the mixing of samples with different systems, the generation of droplets, the secondary amplification and the droplet detection are integrated on the same chip, and the degree of integration and automation can be improved, which is an important technical breakthrough in the field of digital PCR.

In some embodiments, the chip body 1 also has a heating groove disposed adjacent to the primary reaction chamber 11, the primary amplification heating module 4 has a heating protrusion 41, and the heating protrusion 41 can be inserted into the heating groove, and the heating groove is provided so that the heating protrusion 41 can be inserted therein and be in close contact with the primary reaction chamber 11, thereby ensuring the primary amplification heating efficiency. It is understood that the primary amplification heating module 4 can be realized by heating modules in the industry, as long as it can be controlled to be heated in accordance with a predetermined cycle, and its specific implementation principle is not particularly limited by the present invention.

It only needs to have a heating protrusion 41 structure to ensure that the heat generated by the heating can be quickly guided to the heating groove position and achieve efficient heating of the fluid in the primary reaction chamber 11. The aforementioned heating groove may be a tapered groove to ensure a larger contact area between it and the heating protrusion 41 to achieve a higher heat transfer efficiency. In a specific embodiment, the temperature cycling process during the primary amplification process is a pre-denaturation of 95° C. for 10 minutes, followed by 15 temperature cycles of 95° C. for 5 seconds, 60° C. for 15 seconds, and finally 4° C. holding temperature in each cycle. To reduce evaporation, 30 microlitres of a low density anti-volatile reagent may be placed in advance in the primary reaction chamber 11.

In some embodiments, the primary reaction chamber 11 has a plurality of first liquid outlet pipes 31 connected in parallel, each sampling chamber 12 has a second liquid outlet pipe 32 respectively, the second liquid outlet pipe 32 of each sampling chamber 12 and the plurality of first liquid outlet pipes 31 are aggregated in the mixing pipe 33 in a one-to-one corresponding manner, and the plurality of mixing pipes 33 are controllably connected with the plurality of secondary reaction chambers 13 in a one-to-one corresponding manner respectively. In this technical solution, the fluids in the two chambers are guided and aggregated into the mixing pipe 33 through the first liquid outlet pipe 31 and the second liquid outlet pipe 32, so that the primary system and the secondary system in the two chambers are mixed in the mixing pipe 33. This mixing is achieved during the flow process, which can have higher operating efficiency. As a preferred embodiment, the mixing pipe 33 has a plurality of continuous bends, which are staggered along the flow direction of the fluid, forming a substantially S-shaped structure in appearance as shown in FIG. 3, which is capable of increasing the flow resistance of the mixing pipe 33, slowing down the flow speed of the fluid while continuously changing the flow direction of the fluid, so as to make the sample and the system mix more fully, and ultimately form a mixed detection sample. In one embodiment, the fluorescence detection area 16 is located on the mixing pipe 33. The fluorescence detection area 16 is arranged on the mixing pipe 33 and can perform fluorescence detection on the droplets 5 that have completed the secondary amplification in the secondary reaction chamber 13 when they flow from the secondary reaction chamber 13 to the sampling chamber 12. The structural design is more reasonable, the directional multiplexing of the pipe is realized, and the chip structure is more streamlined and compact.

In a specific embodiment, each of the one-to-many mixing and reaction structures further comprises a plurality of fluid flow driving structures, the number of the fluid flow driving structures is equal to the number of the mixing pipes 33 and the two correspond one to one, each of the fluid flow driving structures comprising a gas-liquid interface 14 constructed on the chip body 1, through which a first pressure difference can be formed between the corresponding primary reaction chamber 11 and the secondary reaction chamber 13 and between the sampling chamber 12 and the secondary reaction chamber 13, so that the fluids inside the primary reaction chamber 11 and the sampling chamber 12 respectively flow into the corresponding mixing pipes 33 under the action of the first pressure difference. It should be noted that the first pressure difference is respectively for the pressure difference between the primary reaction chamber 11 and the secondary reaction chamber 13, and between the sample adding chamber 12 and the secondary reaction chamber 13 when the sample is mixed. Although both can be called the first pressure difference, in actual operation, the actual values of the two pressure differences may be different. In this technical solution, by adjusting the specific pressure at the gas-liquid interface 14, a first pressure difference can be formed inside the primary reaction chamber 11 and the sampling chamber 12, thereby effectively driving the fluid flow, and the operation is simple and convenient. It should be noted that the gas-liquid interface 14 is connected to the interior of the secondary reaction chamber 13 through the gas-liquid pipe 34. On the one hand, the fluid flow drive of the one-to-many mixing and reaction structure can be achieved by adjusting the gas pressure (such as negative pressure) at the gas-liquid interface 14. On the other hand, when necessary, the detection driving oil 6 (also known as floating oil) can be introduced into the secondary reaction chamber 13 through the gas-liquid interface 14, so that the droplets 5 in the secondary reaction chamber 13 that have completed the secondary amplification can enter the mixing pipe 33 to achieve fluorescence detection of these droplets 5.

Further, each fluid flow driving structure further comprises an oil-liquid interface 15 constructed on the chip body 1 for connecting the detection separator oil, the oil-liquid interface 15 forming an intersection with the mixing pipe 33 through the oil-liquid pipe 35 to be able to divide the fluid into a plurality of droplets 5 as it flows through the intersection position of the oil-liquid pipe 35 and the mixing pipe 33. As shown in FIG. 5, the external pressure is controlled to drive the detection driving oil 6 to enter the secondary reaction chamber 13 from the gas-liquid interface 14, so that the droplets 5 in the secondary reaction chamber 13 flow out of the secondary reaction chamber 13 to the intersection position, and the external pressure drives the detection separation oil to enter the aforementioned intersection position from the oil-liquid interface 15. The detection separation oil will separate the droplets 5 flowing out of the secondary reaction chamber 13 to the intersection position to form a queue, and enter the fluorescence detection area 16 to complete the fluorescence detection. Specifically, oil (that is, the detection driving oil 6, also called floating oil) is provided to the gas-liquid interface 14, and the droplets 5 after the amplification reaction in the secondary reaction chamber 13 are floated by the buoyancy of the oil, and the droplets 5 can flow out of the secondary reaction chamber 13 and enter the mixing pipe 33 under the buoyancy of the oil, and flow through the droplet observation area 36 to enter the intersection (that is, the aforementioned intersection position), and be detected in the fluorescence detection area 16, and then finally enter the sampling chamber 12. At this time, the sampling chamber 12 is a waste liquid pool.

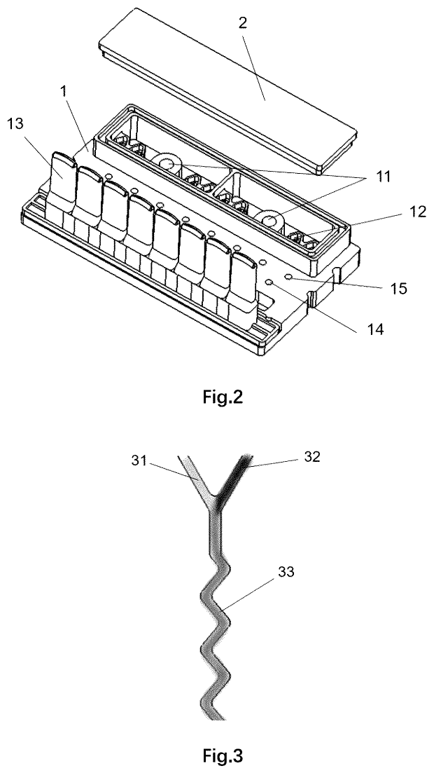

In some embodiments, as shown in FIG. 2, with the first side of the chip body 1 in a horizontal orientation, the secondary reaction chamber 13, the sampling chamber 12, and the primary reaction chamber 11 are on the first side, and the connection interface 111 between the secondary reaction chamber 13 and the first side of the chip body 1 extends upwardly and forms a trumpet with a small bottom and a large top. The connection interface 111 with a flared mouth can facilitate the droplets 5 to enter the secondary reaction chamber 13 from the mixing pipe 33, and also facilitate the droplets 5 to enter the mixing pipe 33 from the secondary reaction chamber 13, preventing the droplets 5 from being retained. It should be noted that at this time, the secondary reaction chamber 13 and the sampling chamber 12 are both on the first side (specifically the top side) of the chip body 1, and the droplets 5 entering the secondary reaction chamber 13 are all gathered at the connection interface 111, and when carrying out the secondary amplification reaction, it is necessary to invert the chip body 1 as a whole, i.e., to flip it over by 180, so that the droplets 5 can be located in the reaction area of the secondary reaction chamber 13.

In some embodiments, the secondary reaction chamber 13 is also constructed with a gas-liquid pipe 34 extending from the bottom to the top, the lower port of the gas-liquid pipe 34 is connected to the gas-liquid interface 14, and the upper port of the gas-liquid pipe 34 is higher than the upper port of the connection interface 111, which prevents the generated droplets 5 from further flowing out from the gas-liquid pipe 34 after entering the secondary reaction chamber 13 when there is a negative pressure in the secondary reaction chamber 13.

In some embodiments, there is a droplet observation area 36 between the mixing pipe 33 and the connection interface 111. The flow area of the droplet observation area 36 is much larger than the flow area of the mixing pipe 33, that is, the droplet observation area 36 is an enlarged area (with a larger width) on the mixing pipe 33, so that the flow rate of the droplets 5 entering the area is reduced, which can facilitate external camera imaging, record the droplet morphology, and determine whether the state of the droplet generation process is normal.

As a specific realization, the primary reaction chamber 11 and the sampling chamber 12 are provided with a sealing cover 2 so that the sealing function can be realized after the operator has added samples into the primary reaction chamber 11 and the sampling chamber 12, and thus will not come into contact with the environment outside the chip, eliminating the possibility of aerosol contamination and realizing a fully closed digital PCR process. Further, the sampling chamber 12 is provided with a filter membrane or an air vent to exclude a certain amount of air when the sampling chamber 12 becomes a waste pool (i.e., when the droplet chip is flipped and inverted), preventing the accumulation of pressure in the sampling chamber 12.

As shown in FIG. 11, another implementation of a fully integrated droplet chip is provided, which differs from the integrated droplet chip shown in FIG. 2 in that the secondary reaction chamber 13 and the sampling chamber 12 are on two opposite sides of the chip body 1. Specifically, the sampling chamber 12 is located on the first side, and the secondary reaction chamber 13 is located on the second side. The second side and the first side are opposite sides of the chip body 1. At this time, the working principle and process of the integrated droplet chip are basically the same as those of the integrated droplet chip described above. The difference is that during the droplet generation process, since the secondary reaction chamber 13 is located on the bottom side of the chip body 1 (the sampling chamber 12 is on the top side), the droplets 5 will directly fall into the reaction area at the bottom of the secondary reaction chamber 13 when they enter the secondary reaction chamber 13, and be collected in the reaction area. Therefore, after the droplet generation is completed, the integrated droplet chip does not need to be flipped 180° and can directly enter the subsequent amplification process.

According to an embodiment of the present invention, a droplet multi-index detection method based on an integrated droplet chip is also provided, the integrated droplet chip comprising a chip body 1, on which at least one set of one-to-many mixing and reaction structures, a droplet generation structure and a fluorescence detection area 16 are constructed in correspondence with each of the one-to-many mixing and reaction structures, and each of the one-to-many mixing and reaction structures comprises a primary reaction chamber 11, a plurality of sampling chambers 12, and a plurality of secondary reaction chambers 13; and the method of droplet multi-index detection comprises the following steps:
a primary amplification reaction step, controlling the heating of the primary system stored in the primary reaction chamber 11, so that the detection sample in the primary system is amplified from a first concentration to a second concentration, and the second concentration is higher than the first concentration;
a sample diverting and mixing step, controlling the first pressure difference to be formed between the primary reaction chamber 11 and the corresponding secondary reaction chamber 13, the sampling chamber 12 and the corresponding secondary reaction chamber 13 respectively, so that the detection sample with the second concentration is mixed with the secondary system in the sampling chamber 12 to form a mixed detection sample;
a droplet generation step, dividing the mixed detection sample into a plurality of droplets 5 under the action of oil in the droplet generation structure, and controlling the formed droplets 5 to enter the secondary reaction chamber 13;
a secondary amplification reaction step, controlling the heating of the droplets 5 stored in the secondary reaction chamber 13 to form secondary amplification;
a droplet fluorescence detection step, performing multi-index fluorescence detection on the mixed detection sample after secondary amplification at the fluorescence detection area 16.

In this technical solution, the chip body 1 has at least one-to-many mixing and reaction structure, and each one-to-many mixing and reaction structure has a primary reaction chamber 11, a plurality of sampling chambers 12, and a plurality of secondary reaction chambers 13, so as to make the detection samples pre-amplified (that is, the aforementioned primary amplification) before generating the droplets 5, so as to effectively increase the concentration of the detection samples, and to improve the concentration of the detection samples after being amplified. The detection sample can be divided into more detection samples under the action of a one-to-many mixing and reaction structure to ensure that each detection sample has a higher concentration, thereby realizing multi-index detection of low-concentration samples, ensuring the sensitivity of sample detection, and improving the accuracy of detection result. At the same time, the primary reaction chamber 11, the sampling chamber 12, and the secondary reaction chamber 13 in this technical solution are all integrated on the same chip body 1, so that the primary amplification, the mixing of samples with different systems, the generation of droplets, the secondary amplification and the droplet detection are integrated on the same chip, and the degree of integration and automation can be improved, which is an important technical breakthrough in the field of digital PCR.

In some embodiments, each fluid flow driving structure further comprises an oil-liquid interface 15 constructed on the chip body 1, the oil-liquid interface 15 forms an intersection with the mixing pipe 33 through the oil-liquid pipe 35. The droplet generation step specifically includes: controlling the second pressure difference between the sampling chamber 12 and the gas-liquid interface 14, and controlling the third pressure difference between the oil-liquid interface 15 and the gas-liquid interface 14, so that the second pressure difference and the third pressure difference drive, respectively, the mixed samples in the mixing pipe 33 and the detected segregated oil (also referred to as the generated oil) in the oil-liquid interface 15 into the intersection position of the oil-liquid pipe 35 and the mixing pipe 33 to form droplets 5, and drive the formed droplets 5 into the secondary reaction chamber 13. Specifically, oil is provided to the oil-liquid interface 15, and negative pressure is provided to the gas-liquid interface 14. Under the action of the negative pressure, the mixed sample in the mixing pipe 33 and the oil at the oil-liquid interface 15 are driven to converge along the mixing pipe 33 and the oil-liquid pipe 35 at the intersection of the two. Under the action of the shear force and surface tension of the oil fluid, the mixed sample forms droplets 5 of uniform size, and finally under the action of the negative pressure the droplets 5 are finally stored in the secondary reaction chamber 13. It should be noted that when the droplets 5 enter the droplet observation area 36, the flow rate of the droplets 5 forms a dense droplet community, which is convenient for camera imaging and recording.

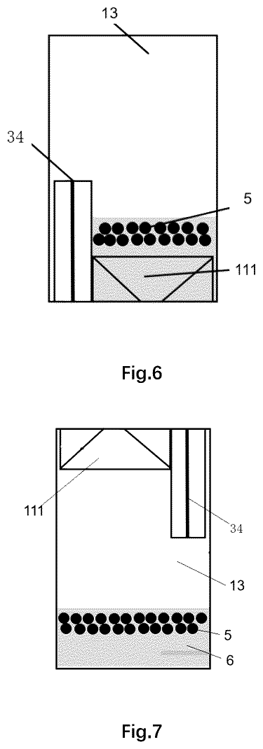

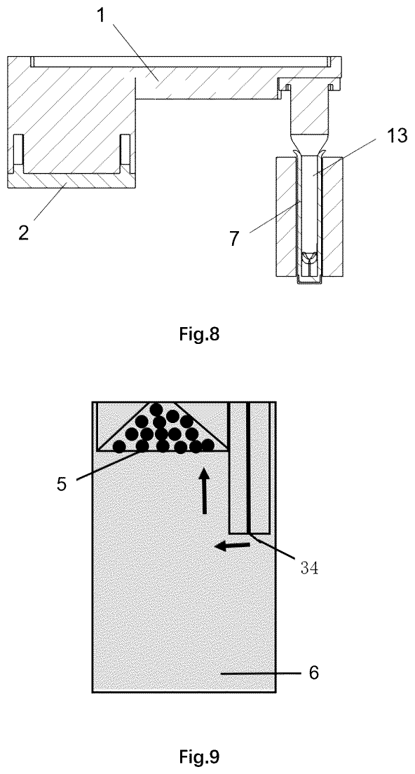

In some embodiments, with reference to the first side of the chip body 1 being in a horizontal orientation, the secondary reaction chamber 13 and the sampling chamber 12 are on the first side, and prior to the secondary amplification reaction step, after the droplet generation step it also includes: a chip flip step, controlling the chip body 1 to flip up and down by 180°. Specifically, the droplets 5 in the secondary reaction chamber 13 are flipped from the side close to the connection interface 111 (FIG. 6) to the side away from the connection interface 111 (FIG. 7). At this time, the position of the secondary reaction chamber 13 corresponding to the droplet 5 is the reaction area of the secondary reaction chamber 13, and the reaction area will enter the secondary amplification heating module 7 (FIG. 8). The secondary amplification heating module 7 should be made of a material with good thermal conductivity. In this example, aluminum alloy material is selected. The width of the middle groove of the secondary amplification heating module 7 should be able to tightly press the reaction area on the secondary reaction chamber 13 to ensure good heating efficiency.

In some embodiments, after the control chip body 1 is flipped up and down 180°, it also includes: a droplet reverse flow control step, controlling the injection of detection driving oil 6 into the secondary reaction chamber 13, so that the droplets 5 in the secondary reaction chamber 13 are driven to flow into the mixing pipe 33, and can be stored in the sample loading chamber 12 after the droplet 5 completes the droplet fluorescence detection step. As before, the sampling chamber 12 at this time serves as a waste liquid pool. When the chip body 1 also has a heating groove arranged adjacent to the primary reaction chamber 11, before the primary amplification reaction step, it also includes: controlling the chip body 1 to move so that the heating groove is sleeved on the heating protrusion 41 of the primary amplification heating module 4, and controlling the primary amplification heating module 4 to perform heating amplification according to a preset cycle.

The following further describes the operation process of the integrated multi-index detection droplet chip of the present invention in combination with the reagent system. First, 60 microlitres of the integrated system is added to the primary reaction chamber 11, the primary system contains the sample to be tested and the pre-amplification system, and then 30 microlitres of the secondary system is added to each of the wells of the sampling chamber 12, respectively, the secondary volume contains the digital PCR system and the stabilizer required for the preparation of the droplets, and the secondary systems added to each of the wells of the sampling chamber 12 are different, mainly the primers and probes are different, and are used for the detection of different target sequences. A chip contains two sets of one-to-four structures (i.e., the aforementioned one-to-many mixing and reaction structures, with the one-to-four reaction detection module being used as an example in this embodiment), i.e., it contains two primary reaction chambers 11 and eight sampling chambers 12, and the two primary reaction chambers 11 are connected to eight sets of channels, each of which contains sampling chambers 12, oil-liquid interfaces 15, gas-liquid interfaces 14, and secondary reaction chambers 13.

Then, the sealing cover 2 is tightly capped or bonded to seal the primary reaction chamber 11 and the sampling chamber 12, and the primary reaction chamber 11 and the sampling chamber 12 are preferably provided with an exhaust hole with a filter membrane or a small calibers.

The chip body 1 is then placed on the primary amplification heating module 4, and the heating protrusion 41 on the primary amplification heating module 4 extends into the corresponding groove (i.e., the aforementioned heating groove) in the chip body 1, and is closely affixed to the outer wall of the primary reaction chamber 11, and the structure of the primary reaction chamber 11 should adopt a design with high heat transfer efficiency, such as adopting a tapered groove that can be tightly affixed to the heating protrusion 41 and so on, so as to achieve a high heat transfer efficiency. In this embodiment, the temperature cycling process is a pre-denaturation of 95° C. for 10 minutes, followed by 15 temperature cycles of 95° C. for 5 seconds, 60° C. for 15 seconds, and finally 4° C. holding time in each cycle. To reduce evaporation, 30 microlitres of a low density anti-volatile reagent may be placed in advance in the primary reaction chamber 11.

Then, negative pressure is provided to the gas-liquid interface 14, and the pressure is −200 mBar, so that a pressure difference is formed between the gas-liquid interface 14 and the primary reaction chamber 11 and the sampling chamber 12. The chip design ensures the consistency of the flow resistance in each first liquid outlet pipe 31, and the pressure difference is controlled to drive the sample in the primary reaction chamber 11 to flow evenly to each first liquid outlet pipe 31, so that 15 microliters of the primary amplified sample will flow evenly into each first liquid outlet pipe 31, and at the same time, the pressure difference is controlled to drive the system in each sampling chamber 12 (the aforementioned secondary system) to flow to the second liquid outlet pipe 32, and 30 microliters of the system flows into each second liquid outlet pipe 32. The sample and the system are mixed in the mixing pipe 33, and then continue to move forward along the mixing pipe 33 under the drive of the first pressure difference. When it reaches the “S” shape position in the mixing pipe 33 (FIG. 3, the “S” shape can make the fluid in the flow channel change direction continuously), the sample and the system are mixed more fully, and finally a mixed sample is formed.

Then, the oil required for droplet generation (i.e., the aforementioned detection separation oil) is provided to the oil-liquid interface 15; negative pressure of −200 mBar is provided to the gas-liquid interface 14, so that a pressure difference is formed between the sampling chamber 12 and the oil-liquid interface 15. The sampling chamber 12 is connected to the mixing pipe 33, the oil-liquid interface 15 is connected to the oil-liquid pipe 35, and the gas-liquid interface 14 is connected to the secondary reaction chamber 13 (through the gas-liquid pipe 34). As shown in FIG. 5, the oil pipe 35 has two branches, which are located on both sides of the mixing pipe 33 and are both connected to the oil-liquid interface 15. The mixing pipe 33 may include a droplet observation area 36. The pipe in the observation area becomes wider, and the flow rate of the droplets decreases after entering, which can facilitate external camera imaging, record the droplet morphology, and determine whether the state of the droplet generation process is normal.

Driven by the pressure difference, the mixed sample enters the mixing pipe 33, and the generated oil enters the oil pipe 35, and intersects at the cross structure (that is, the aforementioned intersection position), and under the action of fluid shear force and surface tension, oil-in-water droplets 5 of uniform size are formed. The channel depth at the intersection is about 70 microns, the width is 80 microns, and the size of the droplet 5 is about 100 microns. After the droplets 5 enter the droplet observation area 36, the flow velocity is reduced to form a dense droplet community, which is convenient for camera imaging and recording. The principle diagram of the droplet generation process is shown in FIG. 5.

The generated droplets 5 arrive at the connection interface 111 of the secondary reaction chamber 13. The bottom of the connection interface 111 has a slope structure (i.e., the aforementioned flare mouth), and at the end of the droplet generation process, the pressure difference applied at the chip interface is withdrawn, at which time the droplets 5 should still be located under the gas-liquid pipe 34 (FIG. 6).

Afterwards, the chip is flipped up and down by 180° to transfer the droplets from the connection interface 111 to the reaction area (i.e., away from the connection interface 111) (FIG. 7), and then the secondary reaction chamber 13 is inserted into the secondary amplification heating module 7 (FIG. 8). The secondary amplification heating module 7 should be made of a material with good thermal conductivity. In this example, aluminum alloy material is selected. The width of the middle groove of the secondary amplification heating module 7 should be able to tightly press the reaction area on the secondary reaction chamber 13 to ensure good heating efficiency, so that the external system (i.e., the heating module) can heat and cool the reaction area from the left and right sides, which not only ensures that the temperature conduction distance is short, but also ensures a large contact area, thereby achieving efficient heat transfer.

In this embodiment, the temperature cycling process is to first perform a pre-denaturation at 95° C. for 10 minutes, followed by 40 temperature cycles, with each cycle being 95° C. for 5 seconds, 60° C. for 15 seconds, and finally 4° C. hold in each cycle.

After the temperature cycle is completed, the secondary amplification reaction within the droplet 5 containing the template is accordingly completed and needs to proceed to the droplet fluorescence detection. The detection oil (i.e. the detection driving oil 6 mentioned above) is injected into the gas-liquid interface 14, continuously filling the secondary reaction chamber 13 (FIG. 9), and then guided by the slope of the connecting interface 111, finally entering the previous droplet observation area 36, and continuing to move forward along the pipe.

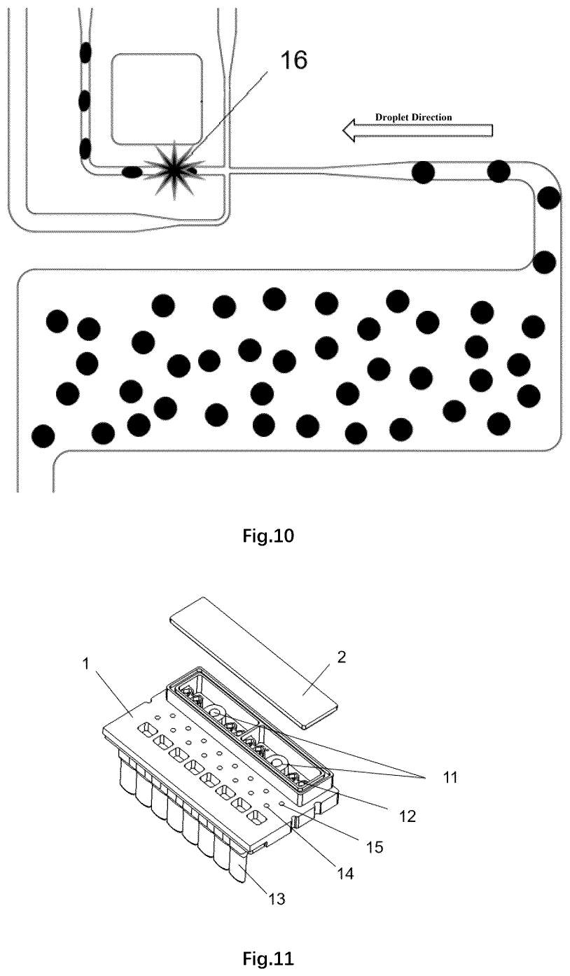

As the droplets pass through the droplet observation area 36, the droplets can also be imaged in the bright field using a camera so that the state of the droplets after the amplification reaction can be evaluated. At the same time, detection oil is injected into the oil-liquid interface 15, which passes through the oil-liquid pipe 35, meets the droplet queue at the intersection, and separates the closely spaced droplets into droplet queues with suitable spacing. The droplet queue passes sequentially through the fluorescence detection area 16 located in the mixing pipe 33, as shown in FIG. 10. The fluorescence detection area 16 corresponds to a position that is the fluorescence detection focus of the external system. The external system focuses excitation light, such as a laser or LED narrow band light with wavelengths of 488 nm, 532 nm and 637 nm, to the detection focal point. As droplet 5 passes through the detection focus sequentially, the fluorescence excited within the droplet, including six types of fluorescence, namely FAM, VIC, TAMRA, ROX, Cy5, and Q705, will also be received by the collection optical path of the external system, thereby obtaining the fluorescence information of each droplet. The fluorescence information of the droplets is used to define the signal threshold, distinguish the positive and negative nature of the droplets, and use the Poisson distribution model to calculate the copy number of the target molecule in the sample.

Each independent secondary reaction chamber 13 can detect 6 kinds of fluorescence, and each fluorescence corresponds to one kind of target sequence, and there are 4 secondary reaction chambers 13 in this embodiment, so one sample can detect 6*4=24 in target molecules, and high sensitivity and multi-index detection are achieved at the same time.

The droplet that finally completes the fluorescence detection enters into the sampling chamber 12, and since the sampling chamber 12 has been sealed by the sealing cover 2, it will not come into contact with the environment outside the chip, eliminating the possibility of aerosol contamination and realizing a fully closed digital PCR process.

In this embodiment, a method of time-sharing multiplexing of the droplet generation structure is innovatively adopted. During droplet generation, the droplet generation structure is utilized to achieve droplet generation. And during droplet fluorescence detection, the droplet generation structure completes the separation of the droplet queue to ensure droplet fluorescence signal detection. By adopting this time-sharing multiplexing method, the first fully integrated and fully closed digital PCR process of sample primary amplification, sample diversion and mixing, droplet generation, secondary amplification, and droplet detection has been realized for the first time on the flow-like digital PCR technology route on a single chip, which is an important technological breakthrough in the field of digital PCR.

In another embodiment, the primary reaction chamber 11 will also be connected to the two first outlet pipes 31 or the eight first outlet pipes 31 to achieve the effect of one-to-two or one-to-eight diversion effect (as in FIGS. 12 and 13), and the specific diversion method is the same as that described above for one-to-four, and will not be discussed in detail. However, the number of detection indicators is different, the 1:2 can detect 12 indicators, and the 1:8 can detect 48 indicators.

### Example 2

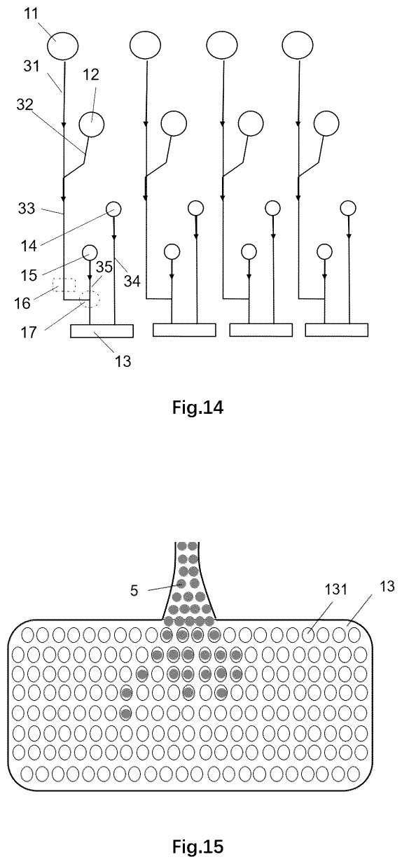

With reference to FIGS. 14, 15 and FIGS. 2 to 11, there is provided, according to an embodiment of the present invention, comprising a chip body 1, on which at least one set of mixing and reaction structures and a fluorescence detection area 16 corresponding to each mixing and reaction structure are constructed, each mixing and reaction structure comprising: a primary reaction chamber 11, for storing a primary system and performing primary amplification (also referred to as pre-amplification), so that a detection sample (specifically, for example, a nucleic acid sample) having a first concentration in the primary system is amplified to form a detection sample having a second concentration, the second concentration being higher than the first concentration; a sampling chamber 12, for storing a secondary system, and the sampling chamber 12 is controllably connected to the primary reaction chamber 11 at the same time; a secondary reaction chamber 13, which is controllably connected to the sampling chamber 12 and the primary reaction chamber through a mixing pipe 33, and the detection sample of the second concentration and the secondary system are mixed in the mixing pipe and stored in the secondary reaction chamber 13 in the form of droplets 5 (specifically, for example, water-in-oil droplets) and undergo secondary amplification, and the fluorescence detection area 16 is used to detect the droplets 5 after the secondary amplification is completed. Specifically, the primary system contains the sample to be detected (such as a nucleic acid sample) and the pre-amplification system, while the secondary system contains the digital PCR system and the stabilizer required for preparing droplets. The secondary system, i.e., the primers and probes required for the secondary reaction, can be added to the sampling chamber 12 according to actual detection requirements. The aforementioned mixing and reaction structure can be implemented in various forms.

In this technical solution, the chip body 1 has at least one mixing and reaction structure, and each mixing and reaction structure has a primary reaction chamber 11, a sampling chamber 12 and a secondary reaction chamber 13, so that the detection sample is first pre-amplified (that is, the aforementioned primary amplification) before generating droplets 5, effectively improving the concentration of the detection sample. The detection sample with increased concentration ensures the sensitivity of detection and improves the accuracy of the detection result. At the same time, the primary reaction chamber 11, the sampling chamber 12 and the secondary reaction chamber 13 in this technical solution are all integrated on the same chip body 1, so that the primary amplification, the mixing of samples and different systems, the generation of droplets, the secondary amplification and the droplet detection are integrated on the same chip, and the degree of integration and automation can be improved. It is an important technical breakthrough in the field of digital PCR.

In some embodiments, the chip body 1 also has a heating groove arranged adjacent to the primary reaction chamber 11, and the primary amplification heating module 4 has a heating protrusion 41, which can be inserted into the heating groove. Through the setting of the heating groove, the heating protrusion 41 can extend into it and be in close contact with the primary reaction chamber 11, thereby ensuring the primary amplification heating efficiency. It can be understood that the primary amplification heating module 4 can be implemented using a heating module in the industry. As long as it can be controlled to heat according to a preset cycle, the specific implementation principle is not particularly limited by the present invention. It only needs to have a heating protrusion 41 structure to ensure that the heat generated by the heating can be quickly guided to the heating groove position and achieve efficient heating of the fluid in the primary reaction chamber 11. The aforementioned heating groove may specifically be a tapered groove to ensure a larger contact area between it and the heating protrusion 41, thereby achieving a higher heat transfer efficiency. In a specific embodiment, the temperature cycling process during the primary amplification process is to first perform a pre-denaturation at 95° C. for 10 minutes, followed by 10 temperature cycles, with 95° C. for 5 seconds, 60° C. for 15 seconds in each cycle, and finally incubation at 4° C. In order to reduce evaporation, 30 μl of a low-density anti-evaporation reagent may be placed in the primary reaction chamber 11 in advance.

In some embodiments, the primary reaction chamber 11 has a first liquid outlet pipe 31, and the sampling chamber 12 has a second liquid outlet pipe 32. The second liquid outlet pipe 32 of the sampling chamber 12 and the first liquid outlet pipe 31 are aggregated in the aforementioned mixing pipe 33, and are controllably connected to the secondary reaction chamber 13. In this technical solution, the fluids in the two chambers are guided and aggregated into the mixing pipe 33 through the first liquid outlet pipe 31 and the second liquid outlet pipe 32, so that the primary system and the secondary system in the two chambers are mixed in the mixing pipe 33. This mixing is achieved during the flow process, which can have higher operating efficiency. As a preferred embodiment, the mixing pipe 33 has a plurality of continuous bends, which are staggered along the flow direction of the fluid, forming a roughly S-shaped structure as shown in FIG. 3, which can increase the flow resistance of the mixing pipe 33, slow down the flow speed of the fluid, and continuously change the flow direction of the fluid, so that the sample and the system are mixed more fully, and finally a mixed detection sample is formed. In one embodiment, the fluorescence detection area 16 is located on the mixing pipe 33. The fluorescence detection area 16 is arranged on the mixing pipe 33 and can perform fluorescence detection on the droplets 5 that have completed the secondary amplification in the secondary reaction chamber 13 when they flow from the secondary reaction chamber 13 to the sampling chamber 12. The structural design is more reasonable, the directional multiplexing of the pipe is realized, and the chip structure is more streamlined and compact.

In a specific embodiment, each mixing and reaction structure also includes a droplet generation structure, and each droplet generation structure includes a gas-liquid interface 14 constructed on the chip body 1, and a first pressure difference can be formed between the corresponding primary reaction chamber 11 and the secondary reaction chamber 13 and between the sampling chamber 12 and the secondary reaction chamber 13 through the gas-liquid interface 14, so that the fluid inside the primary reaction chamber 11 and the sampling chamber 12 respectively flows into the corresponding mixing pipe 33 under the action of the first pressure difference. It should be noted that the aforementioned first pressure difference is respectively for the pressure difference between the primary reaction chamber 11 and the secondary reaction chamber 13, and between the sample adding chamber 12 and the secondary reaction chamber 13 when the sample is mixed. Although both can be called the first pressure difference, in actual operation, the actual values of the two pressure differences may be different. In this technical solution, by adjusting the specific pressure at the gas-liquid interface 14, a first pressure difference can be formed inside the primary reaction chamber 11 and the sampling chamber 12, thereby effectively driving the fluid flow, and the operation is simple and convenient. It should be noted that the gas-liquid interface 14 is connected to the interior of the secondary reaction chamber 13 through the gas-liquid pipe 34. On the one hand, the fluid flow drive of the mixing and reaction structure can be achieved by adjusting the gas pressure (such as negative pressure) at the gas-liquid interface 14. On the other hand, when necessary, the detection driving oil 6 (also called floating oil) can be introduced into the secondary reaction chamber 13 through the gas-liquid interface 14, so that the droplets 5 in the secondary reaction chamber 13 that have completed the secondary amplification can enter the mixing pipe 33 to achieve fluorescence detection of these droplets 5.

Furthermore, each droplet generation structure also includes an oil-liquid interface 15 constructed on the chip body 1, which is used to connect the detection separation oil. The oil-liquid interface 15 is crossed with the mixing pipe 33 through the oil-liquid pipe 35, so that the fluid can be divided into multiple droplets 5 when flowing through the intersection of the oil-liquid pipe 35 and the mixing pipe 33. As shown in FIG. 5, the external pressure is controlled to drive the detection driving oil 6 to enter the secondary reaction chamber 13 from the gas-liquid interface 14, so that the droplets 5 in the secondary reaction chamber 13 flow out of the secondary reaction chamber 13 to the intersection position, and the external pressure drives the detection separation oil to enter the aforementioned intersection position from the oil-liquid interface 15. The detection separation oil will separate the droplets 5 flowing out of the secondary reaction chamber 13 to the intersection position to form a queue, and enter the fluorescence detection area 16 to complete the fluorescence detection. Specifically, oil (that is, the detection driving oil 6, also called floating oil) is provided to the gas-liquid interface 14, and the droplets 5 after the amplification reaction in the secondary reaction chamber 13 are floated by the buoyancy of the oil, and the droplets 5 can flow out of the secondary reaction chamber 13 and enter the mixing pipe 33 under the buoyancy of the oil, and flow through the droplet observation area 36 to enter the cross intersection (that is, the aforementioned intersection position), and be detected in the fluorescence detection area 16, and then finally enter the sampling chamber 12. At this time, the sampling chamber 12 is a waste liquid pool.

In some embodiments, referring to FIG. 2, with the first side surface of the chip body 1 being in a horizontal position as a reference, the secondary reaction chamber 13, the sampling chamber 12, and the primary reaction chamber 11 are all on the first side surface, and the connection interface 111 between the secondary reaction chamber 13 and the first side surface of the chip body 1 extends upward and forms a trumpet-shaped mouth that is small at the bottom and large at the top. The bell-shaped connection interface 111 can facilitate the droplets 5 to enter the secondary reaction chamber 13 from the mixing pipe 33, and also facilitate the droplets 5 to enter the mixing pipe 33 from the secondary reaction chamber 13, thereby preventing the droplets 5 from being detained. It should be noted that at this time, the secondary reaction chamber 13 and the sampling chamber 12 are both located on the first side surface (specifically the top surface) of the chip body 1, and the droplets 5 entering the secondary reaction chamber 13 are all gathered at the connection interface 111. When performing the secondary amplification reaction, the chip body 1 needs to be inverted as a whole, that is, flipped 180°, so that the droplets 5 can be in the reaction area of the secondary reaction chamber 13.

In some embodiments, a gas-liquid pipe 34 extending from bottom to top is also constructed in the secondary reaction chamber 13, and the lower end of the gas-liquid pipe 34 is connected to the gas-liquid interface 14, and the upper end of the gas-liquid pipe 34 is higher than the upper end of the connection interface 111. This can prevent the generated droplets 5 from further flowing out of the gas-liquid pipe 34 after entering the secondary reaction chamber 13 when the secondary reaction chamber 13 is under negative pressure.

In some embodiments, there is a droplet observation area 36 between the mixing pipe 33 and the connection interface 111. The flow area of the droplet observation area 36 is much larger than the flow area of the mixing pipe 33, that is, the droplet observation area 36 is an enlarged area (with a larger width) on the mixing pipe 33, so that the flow rate of the droplets 5 entering the area is reduced, which can facilitate external camera imaging, record the droplet morphology, and determine whether the state of the droplet generation process is normal.

As a specific implementation method, the primary reaction chamber 11 and the sampling chamber 12 are equipped with a sealing cover 2, so that after the operator adds the sample into the primary reaction chamber 11 and the sampling chamber 12, a sealing function can be realized, so that there will be no contact with the environment outside the chip, eliminating the possibility of aerosol contamination and realizing a fully closed digital PCR process. Furthermore, the sampling chamber 12 is provided with a filter membrane or an exhaust hole. When the sampling chamber 12 becomes a waste liquid pool (i.e., when the droplet chip is flipped and inverted), a certain amount of air is exhausted to prevent pressure accumulation in the sampling chamber 12.

As shown in FIG. 11, another implementation of a fully integrated droplet chip is provided. The difference between the integrated droplet chip shown in FIG. 2 is that the secondary reaction chamber 13 and the sampling chamber 12 are respectively located on two opposite sides of the chip body 1. Specifically, the sampling chamber 12 is located on the first side, and the secondary reaction chamber 13 is located on the second side. The second side and the first side are opposite sides of the chip body 1. At this time, the working principle and process of the integrated droplet chip are basically the same as those of the integrated droplet chip described above. The difference is that during the droplet generation process, since the secondary reaction chamber 13 is located on the bottom side of the chip body 1 (the sampling chamber 12 is on the top side), the droplets 5 will directly fall into the reaction area at the bottom of the secondary reaction chamber 13 when they enter the secondary reaction chamber 13, and be collected in the reaction area. Therefore, after the droplet generation is completed, the integrated droplet chip does not need to be flipped 180° and can directly enter the subsequent amplification process.

According to an embodiment of the present invention, a detection method based on an integrated droplet chip is also provided. The integrated droplet chip includes a chip body 1, on which at least one set of mixing and reaction structures, a droplet generation structure and a fluorescence detection area 16 corresponding to each of the mixing and reaction structures are constructed. Each mixing and reaction structure includes a primary reaction chamber 11, a sample addition chamber 12 and a secondary reaction chamber 13. The droplet detection method includes the following steps:
a primary amplification reaction step, controlling the heating of the primary system stored in the primary reaction chamber 11, so that the detection sample in the primary system is amplified from a first concentration to a second concentration, and the second concentration is higher than the first concentration;
a sample diverting and mixing step, controlling the formation of a first pressure difference between the primary reaction chamber 11 and the secondary reaction chamber 13, the sampling chamber 12 and the secondary reaction chamber 13 respectively, so that the detection sample with the second concentration is mixed with the secondary system in the sampling chamber 12 to form a mixed detection sample;
a droplet generation step, dividing the mixed detection sample into a plurality of droplets 5 under the action of oil in the droplet generation structure, and controlling the formed droplets 5 to enter the secondary reaction chamber 13;
a secondary amplification reaction step, controlling the heating of the droplets 5 stored in the secondary reaction chamber 13 to form secondary amplification;
a droplet fluorescence detection step, performing multi-index fluorescence detection on the mixed detection sample after secondary amplification at the fluorescence detection area 16.

In this technical solution, the chip body 1 has at least one mixing and reaction structure, and each mixing and reaction structure has a primary reaction chamber 11, a sampling chamber 12 and a secondary reaction chamber 13, so that the detection sample is first pre-amplified (that is, the aforementioned primary amplification) before generating droplets 5, effectively improving the concentration of the detection sample, ensuring the sensitivity of sample detection, and improving the accuracy of the detection result. At the same time, the primary reaction chamber 11, the sampling chamber 12 and the secondary reaction chamber 13 in this technical solution are all integrated on the same chip body 1, so that the primary amplification, the mixing of samples and different systems, the generation of droplets, the secondary amplification and the droplet detection are integrated on the same chip, and the integration and automation levels can be improved. This is an important technical breakthrough in the field of digital PCR.

In some embodiments, each fluid flow driving structure also includes an oil-liquid interface 15 constructed on the chip body 1, and the oil-liquid interface 15 forms an intersection with the mixing pipe 33 through the oil-liquid pipe 35. The droplet generation step specifically includes: controlling the second pressure difference between the sampling chamber 12 and the gas-liquid interface 14, and controlling the third pressure difference between the oil-liquid interface 15 and the gas-liquid interface 14. The second pressure difference and the third pressure difference respectively drive the mixed detection sample and the generated oil in the mixing pipe 33 to form droplets 5 at the intersection of the oil-liquid pipe 35 and the mixing pipe 33, and drive the formed droplets 5 into the secondary reaction chamber 13. Specifically, a second pressure difference is formed between the sampling chamber 12 and the gas-liquid interface 14, and a third pressure difference is formed between the oil-liquid interface 15 and the gas-liquid interface 14, so that the second pressure difference and the third pressure difference respectively drive the mixed sample in the mixing pipe 33 and the detection separation oil (also called generated oil) of the oil-liquid interface 15 to enter the intersection of the oil-liquid pipe 35 and the mixing pipe 33, and the generated droplets 5 enter and are stored in the secondary reaction chamber 13. Specifically, oil is provided to the oil-liquid interface 15, and negative pressure is provided to the gas-liquid interface 14. Under the action of the negative pressure, the mixed sample in the mixing pipe 33 and the oil at the oil interface 15 are driven along the mixing pipe 33 and the oil pipe 35 respectively to converge at the intersection of the two. The mixed sample forms droplets 5 of uniform size under the action of the shear force and surface tension of the oil fluid, and finally under the action of negative pressure, the droplets 5 are finally stored in the secondary reaction chamber 13. It should be noted that when the droplets 5 enter the droplet observation area 36, the flow rate of the droplets 5 forms a dense droplet community, which is convenient for camera imaging and recording.

In some embodiments, with reference to the first side of the chip body 1 being in a horizontal orientation, the secondary reaction chamber 13 and the sampling chamber 12 are on the first side, and prior to the secondary amplification reaction step, after the droplet generation step further comprises: a chip flip step, controlling the chip body 1 to be flipped up and down by 180°, and, specifically, the droplets 5 in the secondary reaction chamber 13 are flipped from the side close to the connection interface 111 (FIG. 6) to the side away from the connection interface 111 (FIG. 7), at this time the position of the secondary reaction chamber 13 corresponding to the droplet 5 is the reaction area of the secondary reaction chamber 13, and the reaction area will enter into the secondary amplification heating module 7 (FIG. 8), the secondary amplification heating module 7 should be made of a material with good heat conduction, and aluminum alloy is selected in this example, and the width of the middle groove of the secondary amplification heating module 7 should be able to tightly press the reaction area on the secondary reaction chamber 13 to ensure good heating efficiency.

In some embodiments, after controlling the chip body 1 to be flipped up and down by 180°, it also includes: a droplet reverse flow control step, controlling the injection of the detection driving oil 6 into the secondary reaction chamber 13, so that the droplets 5 in the secondary reaction chamber 13 are driven to flow into the mixing pipe 33, and are able to be stored in the sampling chamber 12 after the droplets 5 have completed the droplet fluorescence detection step, as before, and at this time the sampling chamber 12 serves as a waste liquid pool. When the chip body 1 also has a heating groove arranged adjacent to the primary reaction chamber 11, prior to the primary amplification reaction step, it is further comprised of: controlling the chip body 1 to move so that the groove is set over the heating protrusion 41 provided by the primary amplification heating module 4, and controlling the primary amplification heating module 4 to perform heating amplification according to a preset cycle.

Referring to FIG. 12, in a specific embodiment, the secondary reaction chamber 13 is a flat cavity structure, and the fluorescence detection area 16 is constructed on the secondary reaction chamber 13. The detection sample of the second concentration and the secondary system are mixed to form a mixed sample, and the droplets 5 are formed by the interaction between the oil phase entering the secondary reaction chamber 13 and the mixed sample in the flat cavity structure; specifically, the corresponding secondary reaction chamber 13 can pre-store the generated oil, that is, the aforementioned oil phase. Under the combined effect of the flat cavity structure, the mixed sample entering, that is, the mixed sample, automatically undergoes interface rupture in the secondary reaction chamber 13 to form droplets 5, and forms a single-layer flat state. After the generation of the droplets 5 is completed, the droplets 5 are kept in a single-layer flat state for secondary amplification; after the secondary amplification, the external fluorescent imaging module performs fluorescence excitation and imaging on the flat droplets 5, identifies the imaging photos, determines the positive and negative nature of the droplets, and calculates the copy number in the sample based on the Poisson distribution. The aforementioned oil phase may not be pre-stored but introduced in real time.

Alternatively, the flat cavity structure has a plurality of micro-pits 131 on the bottom wall of the cavity, and the droplets 5 are formed by the physical spacing of the mixed samples entering within the micro-pits 131. Specifically, the secondary reaction chamber 13 has thousands or even tens of thousands of micro-pits 131, and the micro-pits 131 are micron-sized pits. After the droplets 5 in the micro-pits 131 are subjected to secondary amplification, an external fluorescence imaging module performs fluorescence excitation and imaging of the tiled droplets 5, and identifies the imaging photographs, determines the droplet negatives and positives, and calculates the number of copies in the sample based on the Poisson distribution. In this embodiment, the generated oil has been pre-stored in the secondary reaction chamber 13. The following further describes the operation process of the integrated pre-amplification droplet chip of the present invention in combination with the reagent system:
First, 15 microliters of the integrated system is added to the primary reaction chamber 11, wherein the primary system contains the sample to be tested and the pre-amplification system. Then, 30 microliters of the secondary system is added to the sampling chamber 12, wherein the secondary volume contains the digital PCR system and the stabilizer required for preparing the droplets. The secondary system, including primers and probes, is added to the sampling chamber 12.

Then, the sealing cover 2 is tightly closed or bonded to seal the primary reaction chamber 11 and the sampling chamber 12. It is preferred that the primary reaction chamber 11 and the sampling chamber 12 have exhaust holes with filter membranes or small calibers.

Then the chip body 1 is placed on the primary amplification heating module 4, and the heating protrusion 41 on the primary amplification heating module 4 extends into the corresponding groove (i.e., the aforementioned heating groove) in the chip body 1, and is closely affixed to the outer wall of the primary reaction chamber 11, and the structure of the primary reaction chamber 11 should adopt a design with high heat transfer efficiency, such as adopting a taper groove that can be tightly affixed to the heating protrusion 41 and so on, so as to achieve a high heat transfer efficiency. In this embodiment, the temperature cycling process is a pre-denaturation of 95° C. for 10 minutes, followed by 10 temperature cycles of 95° C. for 5 seconds, 60° C. for 15 seconds, and a final 4° C. holding time in each cycle. To reduce evaporation, 30 microlitres of low density anti-evaporation reagent may be placed in the primary reaction chamber 11 in advance.

Then a negative pressure is provided to the gas-liquid interface 14 with a pressure magnitude of −200 mBar such that a pressure difference is formed between the gas-liquid interface 14 and the primary reaction chamber 11 and between the gas-liquid interface 14 and the sampling chamber 12, and the controlled pressure difference drives the sample in the primary reaction chamber 11 to flow to the first outlet pipe 31, while the controlled pressure difference drives the system in each sampling chamber 12 (the secondary system as described previously) to flow to the second liquid outlet pipe 32, and the second liquid outlet pipe 32 flows into 30 microlitres of the system, the sample and the system are mixed in the mixing pipe 33, and then continue to move forward along the mixing pipe 33 under the drive of the first pressure difference. When it reaches the “S” shape position in the mixing pipe 33 (FIG. 3, the “S” shape can make the fluid in the flow channel change direction continuously), the sample and the system are mixed more fully, and finally a mixed sample is formed.

Then, the oil-liquid interface 15 is supplied with the generated oil required for droplet generation (i.e., the aforementioned detected separation oil); and the gas-liquid interface 14 is supplied with a negative pressure at a magnitude of −200 mBar, such that a pressure difference is formed between the sampling chamber 12 and the oil-liquid interface 15. Wherein, the sampling chamber 12 is connected to the mixing pipe 33, the oil-liquid interface 15 is connected to the oil-liquid pipe 35, and the gas-liquid interfaces 14 are all connected to the secondary reaction chamber 13 (via the gas-liquid pipe 34). As shown in FIG. 5, the oil-liquid pipe 35 has two branches located on both sides of the mixing pipe 33, and both are connected to the oil-liquid interface 15. The mixing pipe 33 may contain a droplet observation area 36, where the observation area pipe is widened, and the flow rate of the droplets is reduced after they enter, which may facilitate imaging by an external camera to record the droplet morphology, and to determine whether the state of the droplet generation process is normal or not.

Driven by the pressure difference, the mixed sample enters into the mixing pipe 33, and the generated oil enters into the oil-liquid pipe 35, and intersects at the cross structure (i.e., the aforementioned intersection position), and under the action of the fluid shear force and the surface tension, forms the water-in-oil droplets 5 of uniform size. The depth of the pipe at the intersection position is about 70 microns, the width is about 80 microns, and the size of the droplets 5 is about 100 microns. The droplet 5 enters the droplet observation area 36 and reduces the flow rate, forming a dense droplet colony, which is convenient for the camera to image and record, and a schematic diagram of the droplet generation process is shown in FIG. 5.

The generated droplets 5 arrive at the connection interface 111 of the secondary reaction chamber 13. The bottom of the connection interface 111 has a slope structure (i.e., the aforementioned flare mouth), and at the end of the droplet generation process, the pressure difference applied at the chip interface is withdrawn, at which time the droplets 5 should still be located under the gas-liquid pipe 34 (FIG. 6).

Afterwards, the chip is flipped up and down by 180°, so that the droplets are transferred from the connection interface 111 to the reaction area (i.e. away from the connection interface 111) (FIG. 7), and then the secondary reaction chamber 13 is inserted into the secondary amplification heating module 7 (FIG. 8), which should be made of a material with good thermal conductivity, and an aluminum alloy is selected in this example, and the width of the middle groove of the secondary amplification heating module 7 should be able to bring the reaction area on the secondary reaction chamber 13 into a tightly compressed position. The width of the middle groove of the secondary amplification heating module 7 should be able to press the reaction area on the chamber 13 closely together to ensure good heating efficiency, so that the external system (i.e., the heating module) heats and cools the reaction area from the left and right sides, which not only ensures a short distance for temperature conduction, but also ensures a large contact area, thus realizing efficient heat transfer. In this embodiment, the temperature cycling process is a pre-denaturation of 95° C. for 10 minutes, followed by 40 temperature cycles of 95° C. for 5 seconds, 60° C. for 15 seconds, and a final 4° C. holding period in each cycle.

At the end of the temperature cycling, the secondary amplification reaction within the droplet 5 containing the template is accordingly completed and it is necessary to enter the droplet fluorescence detection stage. The detection oil (also known as detection driving oil 6 as described above) is injected into the gas-liquid interface 14, continuously filling the secondary reaction chamber 13 (FIG. 9), and then guided by the slope of the connecting interface 111, finally entering the previous droplet observation area 36, and continuing to move forward along the pipe.

As the droplets pass through the droplet observation area 36, the camera can also be used to perform bright field imaging of the droplets so as to assess the state of the droplets after the amplification reaction. At the same time, detection oil is injected into the oil-liquid interface 15, which passes through the oil-liquid pipe 35, meets the droplet queue at the intersection position, and separates the closely spaced droplets into droplet queues with suitable spacing. The droplet queue passes sequentially through the fluorescence detection area 16 located in the mixing pipe 33, as shown in FIG. 10. The position corresponding to the fluorescence detection area 16 is the fluorescence detection focus of the external system. The external system focuses excitation light, such as a laser or LED narrow band light with wavelengths of 488 nm, 532 nm and 637 nm, to the detection focal point. As droplet 5 passes through the detection focal point sequentially, the fluorescence excited within the droplet, including six types of fluorescence, namely FAM, VIC, TAMRA, ROX, Cy5, and Q705, will also be received by the acquisition light path of the external system, so as to obtain the fluorescence information of each droplet. Using the fluorescence information of the droplets, a signal threshold is delineated to differentiate between the negative and positive of the droplets, and the copy number of the target molecule in the sample is calculated using the Poisson distribution model.

The droplet that finally completes the fluorescence detection enters into the sampling chamber 12, and since the sampling chamber 12 has been sealed by the sealing cover 2, it does not come into contact with the environment outside the chip, eliminating the possibility of aerosol contamination and realizing a fully closed digital PCR process.

In this embodiment, a method of time-sharing multiplexing of the droplet generation structure is innovatively adopted. During droplet generation, the droplet generation structure is utilized to achieve droplet generation. And during droplet fluorescence detection, the droplet generation structure completes the separation of the droplet queue to ensure droplet fluorescence signal detection. By adopting this time-sharing multiplexing method, a fully integrated and closed digital PCR process of sample primary amplification, sample diversion and mixing, droplet generation, secondary amplification, and droplet detection can be completed on a single chip for the first time in the flow-like digital PCR technology route. This is an important technological breakthrough in the field of digital PCR.

In another embodiment, fluorescence imaging may be used for fluorescence detection of droplets after secondary amplification. In this embodiment, the secondary reaction chamber 13 includes a fluorescence detection area, as in FIG. 12. In this embodiment, the steps before the generation of droplets are the same as those in the above embodiment. In the droplet generation step, the oil phase also interacts with the mixed sample to form droplets of uniform size. After the droplets are generated, they enter the secondary reaction chamber to form a single-layer flat droplet layer, and remain in the flat state for secondary amplification. After secondary amplification, the external fluorescence imaging module performs fluorescence excitation and imaging on the spread droplets, identifies the imaging photos, determines the positive and negative nature of the droplets, and calculates the copy number in the sample based on the Poisson distribution.

In another embodiment, fluorescence imaging may be used for fluorescence detection of the droplets after secondary amplification. In this embodiment, the secondary reaction chamber 13 includes a fluorescence detection area. In this embodiment, the steps prior to droplet generation are the same as in the above embodiment. In the droplet generation step, the generated oil is pre-stored in the secondary reaction chamber 13. Relying on the pipe structure, the mixed sample is allowed to automatically undergo interface rupture in the secondary reaction chamber 13 to form droplets and form a single-layer flat state. After the droplet generation is completed, the droplets remain in a single layer flat state for secondary amplification. After secondary amplification, the external fluorescence imaging module excites and images the tiled droplets, identifies the imaged photos, determines the positive and negative nature of the droplets, and calculates the copy number in the sample based on the Poisson distribution. In this embodiment, the generated oil has been pre-stored in the secondary reaction chamber 13.

In another embodiment, fluorescence imaging may be used for fluorescence detection of droplets after secondary amplification. In this embodiment, the secondary reaction chamber 13 contains a fluorescence detection area. In this embodiment, the steps prior to droplet generation are the same as in the above embodiment. A plurality of micro-pits 131 are contained in the secondary reaction chamber 13, the micro-pits having a micron scale. In the droplet generation step, the mixed sample sequentially fills the micropits and the micropits are used to form spatially separated individual droplets.

After droplet generation, the micropits may be sealed using oil for further separation of each droplet. After the droplets in the micropits are subjected to secondary amplification, an external fluorescence imaging module performs fluorescence excitation and imaging of the tiled droplets, and identifies the imaging photographs, determines the droplet negatives and positives, and calculates the number of copies in the sample based on the Poisson distribution. In this embodiment, the generated oil has been pre-stored in the secondary reaction chamber 13.

It is easy for those skilled in the art to understand that the above-mentioned advantageous methods can be freely combined and superimposed without conflict.

The above is only a preferred embodiment of the present invention, and is not intended to limit the present invention, and any modifications, equivalent substitutions and improvements made within the spirit and principles of the present invention shall be included in the scope of protection of the present invention. The above is only a preferred embodiment of the present invention, it should be pointed out that, for the person of ordinary skill in the art, on the premise of not departing from the technical principles of the present invention, a number of improvements and variations can be made, which should also be regarded as the scope of protection of the present invention.

1. An integrated multi-index detection droplet chip, comprising a chip body (1), the chip body (1) being constructed with at least one set of one-to-many mixing and reaction structures, a droplet generating structure and a fluorescence detection area (16) corresponding to each of the one-to-many mixing and reaction structures, and each of the one-to-many mixing and reaction structures comprises:
a primary reaction chamber (11), used for storing a primary system and performing primary amplification, so that a detection sample with a first concentration in the primary system is amplified to form a detection sample with a second concentration, wherein the second concentration is higher than the first concentration;
a plurality of sampling chambers (12), used for storing a secondary system, and the plurality of sampling chambers (12) are controllably connected to the same primary reaction chamber (11) at the same time;
a plurality of secondary reaction chambers (13), which are controllably connected to the plurality of sampling chambers (12) in a one-to-one correspondence, are used to store the droplets (5) generated by the detection sample of the second concentration and the secondary system at the droplet generating structure and perform secondary amplification;
the fluorescence detection area (16) which is used for detecting droplets (5) after secondary amplification.

2. The integrated multi-index detection droplet chip according to claim 1, wherein the primary reaction chamber (11) has a plurality of first liquid outlet pipes (31) connected in parallel, each of the sampling chambers (12) has a second liquid outlet pipe (32) respectively, the second liquid outlet pipe (32) of each of the sampling chambers (12) is aggregated in a mixing pipe (33) in a one-to-one correspondence with a plurality of the first liquid outlet pipes (31), and a plurality of the mixing pipes (33) are controllably connected to a plurality of the secondary reaction chambers (13) in a one-to-one correspondence respectively.

3. The integrated multi-index detection droplet chip according to claim 2, wherein each of the one-to-many mixing and reaction structures further comprises a plurality of fluid flow driving structures, the number of the fluid flow driving structures being equal to the number of the mixing pipes (33), each of the fluid flow driving structures comprising a gas-liquid interface (14) constructed on the chip body (1), through which a first pressure difference can be formed between the corresponding primary reaction chamber (11) and the secondary reaction chamber (13) and between the sampling chamber (12) and the secondary reaction chamber (13), so that the fluids inside the primary reaction chamber (11) and the sampling chamber (12) respectively flow into the corresponding mixing pipes (33) under the action of the first pressure difference.

4. The integrated multi-index detection droplet chip according to claim 3, wherein each of the fluid flow driving structures further comprises an oil-fluid interface (15) constructed on the chip body (1), and the oil-liquid interface (15) intersects with the mixing pipe (33) through the oil-liquid pipe (35), so that the fluid can be divided into a plurality of droplets (5) when flowing through the intersection of the oil-liquid pipe (35) and the mixing pipe (33).

5. A droplet multi-index detection method using the integrated multi-index detection droplet chip as claimed in claim 4, wherein the method comprises the following steps:
a primary amplification reaction step, controlling the heating of the primary system stored in the primary reaction chamber (11), so that the detection sample in the primary system is amplified from a first concentration to a second concentration, and the second concentration is higher than the first concentration;
a sample diverting and mixing step, controlling the formation of a first pressure difference between the primary reaction chamber (11) and the secondary reaction chamber (13), the sampling chamber (12) and the secondary reaction chamber (13) respectively, so that the detection sample with the second concentration is mixed with the secondary system in the sampling chamber (12) to form a mixed detection sample;
a droplet generation step, dividing the mixed detection sample into a plurality of droplets (5) under the action of oil in the droplet generation structure, and controlling the formed droplets (5) to enter the secondary reaction chamber (13);
a secondary amplification reaction step, controlling the heating of the droplets (5) stored in the secondary reaction chamber (13) to form secondary amplification;
a droplet fluorescence detection step, performing multi-index fluorescence detection on the mixed detection sample after secondary amplification at the fluorescence detection area (16).

6. The droplet multi-index detection method according to claim 5, wherein the droplet generation step specifically comprises:
controlling the formation of a second pressure difference between the sampling chamber (12) and the gas-liquid interface (14), and controlling the formation of a third pressure difference between the oil-liquid interface (15) and the gas-liquid interface (14), the second pressure difference and the third pressure difference driving the mixed detection sample and the generating oil in the mixing pipe (33), respectively, at the intersection of the oil-liquid pipes (35) and the mixing pipes (33) to form the droplets (5) and driving the formed droplets (5) into the secondary reaction chamber (13).

7. The droplet multi-index detection method according to claim 6, wherein prior to the secondary amplification reaction step and after the droplet generation step it further comprises a chip flip step, controlling the chip body (1) to flip up and down by 180°.

8. The droplet multi-index detection method according to claim 7, wherein after controlling the chip body (1) to be flipped up and down 180°, it further comprises: a droplet reverse flow control step, controlling the injection of detection driving oil (6) into the secondary reaction chamber (13), so that the droplets (5) in the secondary reaction chamber (13) can be driven to flow into the mixing pipe (33) and can be stored in the sampling chamber (12) after the droplets have completed a droplet fluorescence detection step.

9. An integrated pre-amplification droplet chip, comprising a chip body (1), wherein the chip body (1) is constructed with at least one set of mixing and reaction structures, fluorescence detection areas (16) set up in correspondence with each of the mixing and reaction structures, each of the mixing and reaction structures comprising:
a primary reaction chamber (11), used to store a primary system and perform primary amplification, so that a detection sample with a first concentration in the primary system is amplified to form a detection sample with a second concentration, and the second concentration is higher than the first concentration;
a sampling chamber (12), used to store a secondary system, and the sampling chamber (12) is controllably connected to the primary reaction chamber (11) at the same time;
a secondary reaction chamber (13), which is controllably connected to the sampling chamber (12) and the primary reaction chamber (11) through a mixing pipe (33), and the detection sample with the second concentration and the secondary system are mixed in the mixing pipe (33) and stored in the secondary reaction chamber (13) in the form of droplets (5) and undergo secondary amplification;
the fluorescence detection area (16) is used to detect droplets (5) after the secondary amplification is completed.

10. The integrated multi-index detection droplet chip according to claim 1 wherein the chip body (1) also has a heating groove disposed adjacent to the primary reaction chamber (11), and a primary amplification heating module (4) has a heating protrusion (41), which can be inserted into the heating groove.

11. The integrated multi-index detection droplet chip according to claim 2 wherein the mixing pipe (33) has a plurality of successive bends.

12. The integrated multi-index detection droplet chip according to claim 2 wherein, with the first side surface of the chip body (1) being in a horizontal position as a reference, the secondary reaction chamber (13), the sampling chamber (12), and the primary reaction chamber (11) are all located on the first side surface, and the connection interface (111) between the secondary reaction chamber (13) and the first side surface of the chip body (1) extends upward and forms a trumpet-shaped mouth that is small at the bottom and large at the top.

13. The integrated multi-index detection droplet chip according to claim 1, wherein a gas-liquid pipe (34) extending from bottom to top is also constructed in the secondary reaction chamber (13), the lower end of the gas-liquid pipe (34) is connected to the gas-liquid interface (14), and the upper end of the gas-liquid pipe (34) is higher than the upper end of the connection interface (111).

14. The integrated pre-amplification droplet chip according to claim 9, wherein the chip body (1) also has a heating groove disposed adjacent to the primary reaction chamber (11), and a primary amplification heating module (4) has a heating protrusion (41), which can be inserted into the heating groove.

15. The integrated pre-amplification droplet chip according to 9, wherein the mixing pipe (33) has a plurality of successive bends.

16. The integrated pre-amplification droplet chip according to 9, wherein, with the first side surface of the chip body (1) being in a horizontal position as a reference, the secondary reaction chamber (13), the sampling chamber (12), and the primary reaction chamber (11) are all located on the first side surface, and the connection interface (111) between the secondary reaction chamber (13) and the first side surface of the chip body (1) extends upward and forms a trumpet-shaped mouth that is small at the bottom and large at the top.

17. The integrated pre-amplification droplet chip according to 9, wherein a gas-liquid pipe (34) extending from bottom to top is also constructed in the secondary reaction chamber (13), the lower end of the gas-liquid pipe (34) is connected to the gas-liquid interface (14), and the upper end of the gas-liquid pipe (34) is higher than the upper end of the connection interface (111).
